(19) United States
(12) Patent Application Publication
(10) Pub. No.: US 2014/0220396 A1
(43) Pub. Date: Aug. 7, 2014

(54) BATTERY PACK

(71) Applicants: ROBERT BOSCH GMBH, Stuttgart (DE); SAMSUNG SDI CO., LTD., Yongin-si (KR)

(72) Inventors: Jang-Wook LEE, Yongin-si (KR); Tae-Yong KIM, Yongin-si (KR)

(73) Assignees: ROBERT BOSCH GMBH, Stuttgart (DE); SAMSUNG SDI CO., LTD., Yongin-si (KR)

(21) Appl. No.: 14/149,892

(22) Filed: Jan. 8, 2014

(30) Foreign Application Priority Data
Feb. 5, 2013 (KR) 10-2013-0012909

(51) Int. Cl. H01M 2/10

(52) U.S. Cl. CPC H01M 2/1077
USPC 429/61; 429/159; 429/90

(57) ABSTRACT

A battery pack including an upper battery module including a plurality of upper battery cells arranged in one direction, the plurality of upper battery cells having upper terminal portions, an upper bus-bar electrically connecting the upper terminal portions, and an upper housing accommodating the plurality of upper battery cells therein; and a lower battery module including a plurality of lower battery cells arranged in the one direction, the plurality of lower battery cells having lower terminal portions, a lower bus-bar electrically connecting the lower terminal portions, and a lower housing accommodating the plurality of lower battery cells therein, wherein a space portion is formed at one end of any one of the upper and lower battery modules, and a controller is positioned in the space portion.

### CROSS-REFERENCE TO RELATED APPLICATION

Korean Patent Application No. 10-2013-0012909 filed on Feb. 5, 2013, in the Korean Intellectual Property Office, and entitled: “BATTERY PACK,” is incorporated by reference herein in its entirety.

### BACKGROUND

1. Field

Embodiments provide a battery pack.

2. Description of the Related Art

Battery cells may be used as energy sources for mobile devices, electric vehicles, hybrid vehicles, and the like. A shape of the battery cell may be variously changed depending on the kind of external device to which the battery cell is applied.

### SUMMARY

Embodiments are directed to a battery pack.

The embodiments may be realized by providing a battery pack including an upper battery module including a plurality of upper battery cells arranged in one direction, the plurality of upper battery cells having upper terminal portions, an upper bus-bar electrically connecting the upper terminal portions, and an upper housing accommodating the plurality of upper battery cells therein; and a lower battery module including a plurality of lower battery cells arranged in the one direction, the plurality of lower battery cells having lower terminal portions, a lower bus-bar electrically connecting the lower terminal portions, and a lower housing accommodating the plurality of lower battery cells therein, wherein a space portion is formed at one end of any one of the upper and lower battery modules, and a controller is positioned in the space portion.

One side of the controller may be connected to a portion of the upper bus-bar at an end of the upper battery module, and another side of the controller may be connected to a portion of the lower bus-bar positioned at an end of the lower battery module.

The controller may include an upper hole at one side thereof, the upper bus-bar may include a first hole aligned with the upper hole, the controller may include a lower hole at another side thereof, the lower bus-bar may include a second hole aligned with the lower hole, the upper hole and the first hole may be fastened to each other with one first fastening member, and the lower hole and the second hole may be fastened to each other with another first fastening member.

The upper bus-bar may be downwardly bent along one end surface of the upper housing from an upper surface of the upper battery module.

The lower bus-bar may be upwardly bent along the one end surface of the upper housing from an upper surface of the lower battery module.

The space portion may be at the one end of the upper battery module, and a bottom surface, on which the space portion of the upper housing is formed, may extend to cover an upper surface of the lower housing, the bottom surface including a through-portion through which the lower bus-bar passes.

The battery pack may further include a controller cover on an outside of the controller.

The controller cover may include a cover fixing hole, the upper housing may include a cover fixing groove, the cover fixing groove being aligned with the cover fixing hole, and the cover fixing hole and the cover fixing groove may be fastened to each other with a second fastening member.

The controller cover may cover the controller, a connection between the controller and the upper bus-bar, and a connection between the controller and the lower bus-bar.

The controller may include at least one selected from the group of a fuse, a junction box, a battery control unit (BCU), a fan, and a temperature measurer.

The upper hosing may further include an upper flange portion on both side portions of a bottom surface thereof, the upper flange portion being bent toward a side surface of the lower housing from, and the lower housing may further include a lower flange portion extending from both side surfaces thereof, the lower flange portion contacting an inner surface of the upper flange portion.

The upper flange portion may include at least one upper module fastening hole, the lower flange portion may include a lower module fastening hole, the lower fastening hole being aligned with the upper module fastening hole, and the upper and lower module fastening holes may be fastened to each other with a third fastening member.

The upper housing may have an open upper end, and the battery pack may further include an upper cover covering the open upper end of the upper housing.

A number of the upper battery cells in the battery pack may be smaller than a number of the lower battery cells in the battery pack.

### BRIEF DESCRIPTION OF THE DRAWINGS

Features will become apparent to those of skill in the art by describing in detail exemplary embodiments with reference to the attached drawings in which:

FIG. 1 illustrates a perspective view of a battery pack according to an embodiment.

FIG. 2 illustrates an exploded perspective view of the battery pack of FIG. 1.

FIG. 3 illustrates a sectional view taken along line A-A′ of FIG. 1.

FIG. 4 illustrates a perspective view showing a state in which a controller is connected to an upper battery module according to an embodiment.

FIG. 5 illustrates a perspective view showing the upper battery module according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the following detailed description, only certain exemplary embodiments have been shown and described, simply by way of illustration. As those skilled in the art would realize, the described embodiments may be modified in various different ways, all without departing from the spirit or scope of the embodiments. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. In the drawings, the thickness or size of layers are exaggerated for clarity and not necessarily drawn to scale.

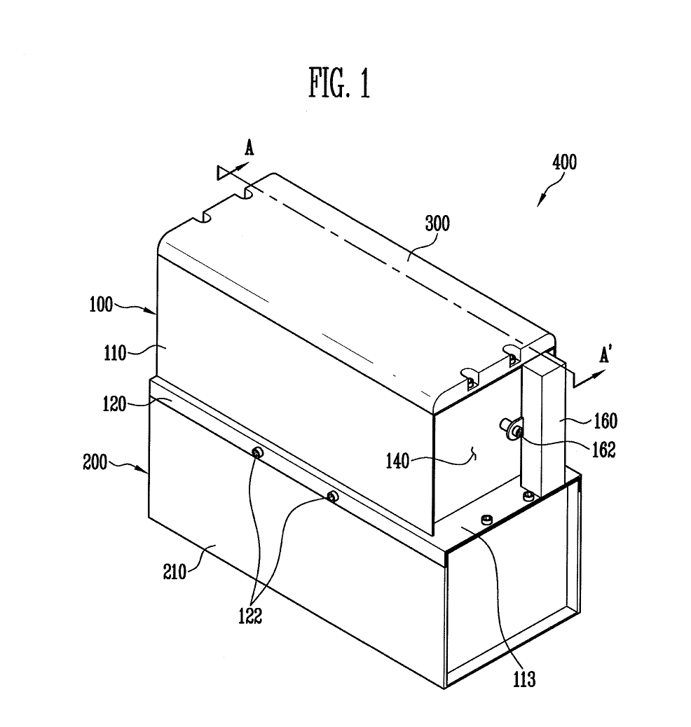

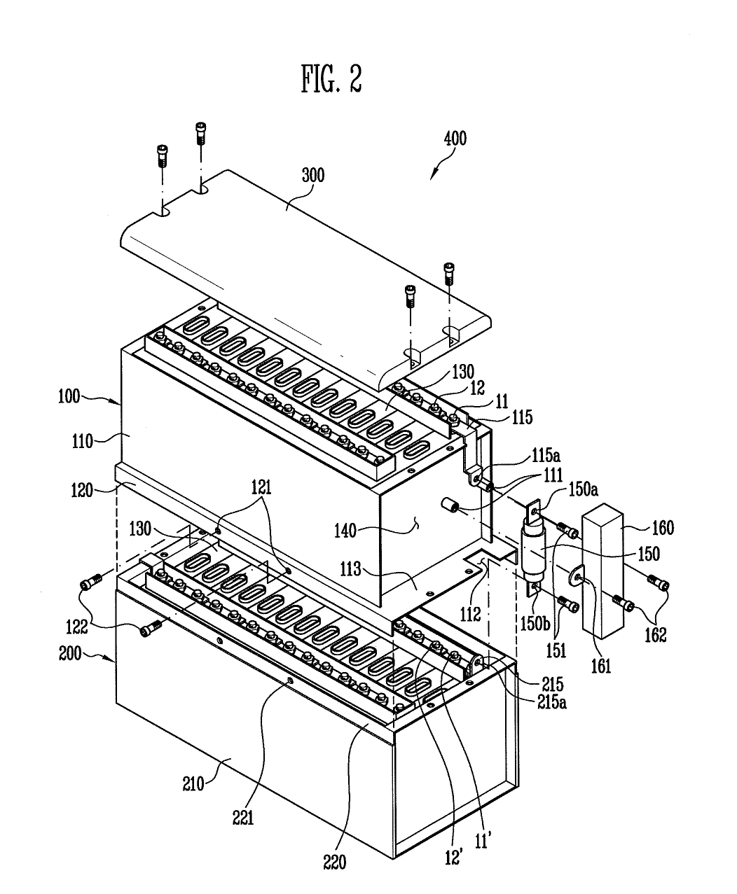

FIG. 1 illustrates a perspective view of a battery pack according to an embodiment. FIG. 2 illustrates an exploded perspective view of the battery pack of FIG. 1.

Referring to FIGS. 1 and 2, the battery pack 400 according to this embodiment may include an upper battery module 100, a lower battery module 200, and a controller 150.

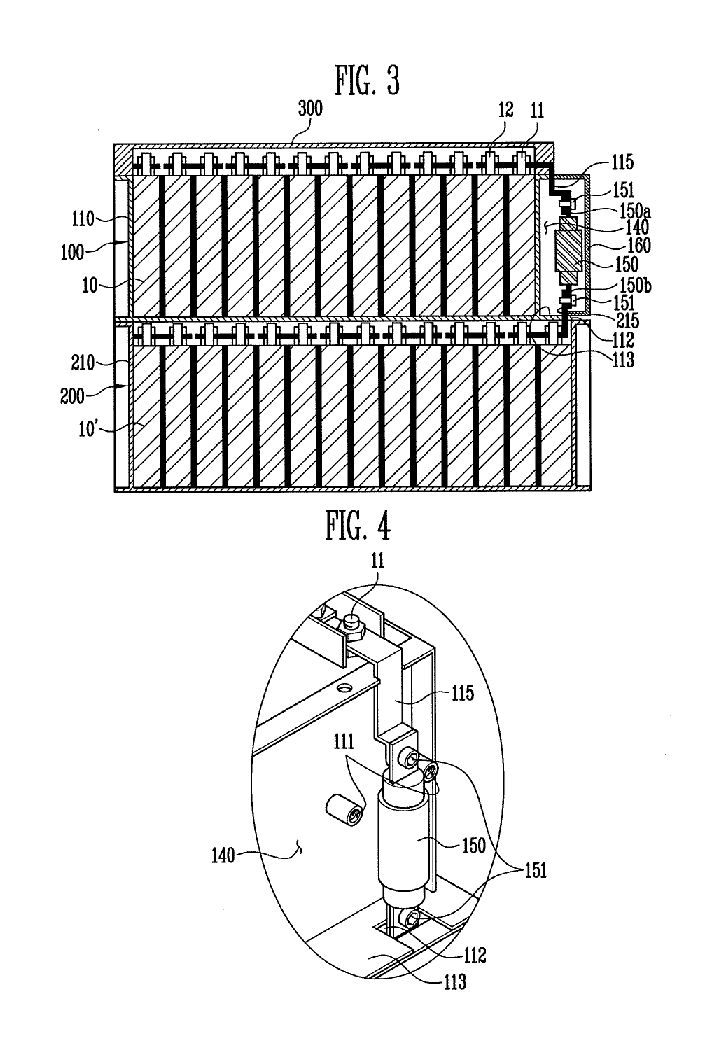

The upper battery module 100 may include upper terminal portions 11 and 12 on a plurality of upper battery cells 10 (see FIG. 3) (having an upper bus-bar 115 electrically connecting the upper terminal portions 11 and 12), and an upper housing 110 accommodating the plurality of upper battery cells 10 therein. The lower battery module 200 may include lower terminal portions 11′ and 12′ on a plurality of lower battery cells 10′ (see FIG. 3) (having a lower bus-bar 215 electrically connecting the lower terminal portions 11′ and 12′), and a lower housing 210 accommodating the plurality of lower battery cells 10′ therein.

In an implementation, a number of the upper battery cells 10 of the upper battery module 100 may be smaller than a number of the lower battery cells 10′ of the lower battery module 200. For example, the battery pack 400 may include thirteen of the upper battery cells 10, and fourteen of the lower battery cells 10′. Accordingly, a space portion 140 may be formed at one end of the upper battery module 100, and the controller 150 may be positioned at or in the space portion 140.

In an implementation, the controller 150 may include at least one selected from the group of a fuse, a junction box, a battery control unit (BCU), a fan, and a temperature measurer. In the battery pack having the battery modules arranged vertically (as shown in FIG. 1), the controller 150 may be positioned at or in the space portion 140 of the upper battery module 100, thereby improving space efficiency. In an implementation, the controller 150 may be mounted at an outside of the battery pack, thereby facilitating cooling and replacement of the controller 150.

One side or end of the controller 150 may be connected to a portion of the upper bus-bar 115 that is positioned at an end of the upper battery module 100, and another side or end of the controller 150 may be connected to a portion of the lower bus-bar 125 that is positioned at an end of the lower battery module 200. For example, the upper bus-bar 115 may be downwardly bent along one end surface of the upper housing 110 from an upper surface of the upper battery module 100, i.e., the upper surface on which the upper terminal portions 11 and 12 are included. The lower bus-bar 215 may be upwardly bent along the one end surface of the upper housing 110 from an upper surface of the lower battery module 200, i.e., the upper surface on which the lower terminal portions 11′ and 12′ are included.

In an implementation, the controller 150 may include an upper hole 150a at one side or end thereof, and the upper bus-bar 115 may include a first hole 115a corresponding to or aligned with the upper hole 150a. The controller may include a lower hole 150b at another side or end thereof, and the lower bus-bar 215 may include a second hole 215a corresponding to or aligned with the lower hole 150b. Accordingly, the upper hole 150a at the one side of the controller 150 and the first hole 115a of the upper bus-bar 115 may be fastened to each other with one first fastening member 151, and the lower hole 150b at the other side of the controller 150 and the second hole 215a of the lower bus-bar 215 may be fastened to each other with another fastening member 151.

In an implementation, although not shown in these figures, a groove portion having the first fastening member 151 extended and fixed thereto may be additionally formed in the upper housing 110 so that the controller 150 may be more firmly fixed to the upper and lower bus-bars 115 and 215.

A bottom surface 113 (on which the space portion 140 of the upper housing 110 may be formed) may extend to cover an upper surface of the lower housing 210. In an implementation, a through-portion 112 (through which the lower bus-bar 215 passes) may be provided in the bottom surface 113. Accordingly, the lower bus-bar 215 may be connected to the other side of the controller 150.

In order to help prevent the controller 150 from being exposed at the outside of the battery pack, a controller cover 160 (surrounding the controller 150) may be further formed at the outside of the controller 150. In an implementation, upper and lower portions of the controller cover 160 may extend so that the downwardly bent upper bus-bar 115 and the upwardly bent lower bus-bar 215 are covered, e.g., not exposed to the outside. In an implementation, the controller cover 160 may be formed of an insulating material.

The controller cover 160 may include at least one cover fixing hole 161. A cover fixing groove 111 may be formed in the upper housing 110 to correspond or be aligned with the cover fixing hole 161. Accordingly, the cover fixing hole 161 and the cover fixing groove 111 may be fastened to each other by a second fastening member 162, so that the controller cover 160 may be fixed to the outside of the upper housing 110.

Hereinafter, a state in which the upper and lower battery modules 100 and 200 are fastened to each other will be described. The upper hosing 110 may further include an upper flange portion 120 bent toward sides of the lower housing 210 from both side portions or edges of the bottom surface 113 of the upper housing 110. The lower housing 210 may further include a lower flange portion 220 extending from both side surfaces of the lower housing 210 so as to contact an inner surface or side of the upper flange portion 120.

At least one upper module fastening hole 121 may be formed in the upper flange portion 120. A lower module fastening hole 221 (corresponding to or aligned with the upper module fastening hole 121) may be formed in the lower flange portion 220. Accordingly, the upper and lower module fastening holes 121 and 221 may be fastened to each other by a third fastening member 122, so that the upper and lower battery modules 100 and 200 may be fastened each other.

A degassing cover may be formed at an upper portion of each of the upper and lower battery cells 10 and 10′ of the upper and lower battery modules 100 and 200, which will be described in detail below with reference to FIG. 5. The upper housing 110 according to the present embodiment may have an opened upper end or surface, and an upper cover 300 may be included on the upper housing 110 at the opened upper end.

As illustrated in FIGS. 1 and 2, the space portion 140 may be formed on only the one end surface of the upper battery module 100. However, in an implementation, a space portion may be formed on another end surface of the upper battery module 100 by adjusting a number of the upper battery cells 10 of the upper battery module 100 when desired.

FIG. 3 illustrates a sectional view taken along line A-A′ of FIG. 1.

As shown in FIG. 3, the number of the upper battery cells 10 in the upper battery module 100 may be smaller than the number of the lower battery cells 10′ in the lower battery module 200. As shown in this figure, in an implementation, the number of the upper battery cell 10 may be 13, and the number of the lower battery cells 10′ may be 14. Accordingly, the space portion 140 may be formed at one end of the upper battery module 100.

The controller 150, e.g., a fuse, junction box, BCU, fan, or temperature measurer, may be positioned at or in the space portion 140. The controller 150 may be fastened to the outer surface of the upper housing 110, on or at which the space portion 140 is positioned. In an implementation, one and another, e.g., opposing, sides or ends of the controller 150 may be connected to the upper and lower bus-bars 115 and 215, respectively. The upper bus-bar 115 (positioned at the end of the upper battery module 100) may be downwardly bent along the one end surface of the upper housing 110 from the upper surface of the upper battery module 100. The lower bus-bar 215 (positioned at the end of the lower battery module 200) may be upwardly bent along the one end surface of the upper housing 110 from the upper surface of the lower battery module 200.

In an implementation, the upper hole 150a may be formed at the one side or end of the controller 150, and the lower hole 150b may be formed at the other side or end of the controller 150. The first hole 115a may be formed in the downwardly bent upper bus-bar 115, and the second hole 215a may be formed in the upwardly bent lower bus-bar 215. Accordingly, the upper hole 150a at the one side of the controller 150 and the first hole 115a of the upper bus-bar 115 may be be fastened to each other by the first fastening member 151, and the lower hole 150b at the other side of the controller 150 and the second hole 215a of the lower bus-bar 215 may be fastened to each other by another first fastening member 151.

The bottom surface 113 (on which the space portion 140 of the upper housing 110 may be formed) may extend to cover the upper surface of the lower housing 210. In an implementation, the through-portion 112 may be formed in the bottom surface 113 (on which the space portion 140 of the upper housing 110 is formed) so that the upwardly bent lower bus-bar 215 may be connected to the other side or end of the controller 150.

In addition, the insulating controller cover 160 (surrounding the controller 150) may be further provided at the outside of the controller 150. In an implementation, the controller cover 160 may also cover the downwardly bent upper bus-bar 115 and the upwardly bent lower bus-bar 215 so that the downwardly bent upper bus-bar 115 and the upwardly bent lower bus-bar 215 are not exposed to the outside.

As described above, the controller 150 may be positioned at or in the space portion 140 of the upper battery module 100, so that it is possible to help improve the space efficiency of the battery pack and to facilitate cooling and replacement of the controller 150.

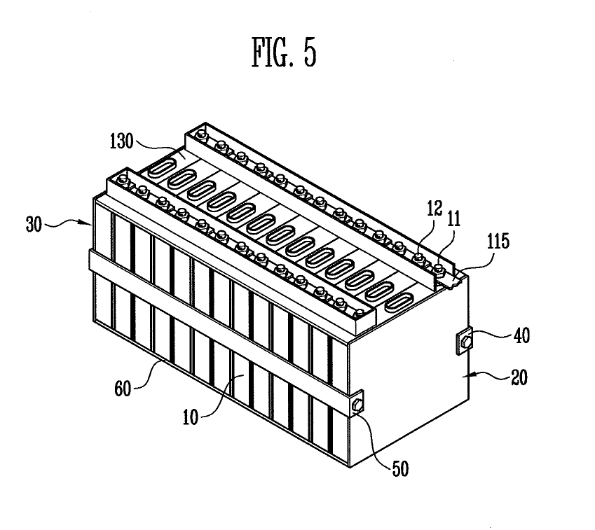

FIG. 4 illustrates a perspective view showing a state in which a controller is connected to an upper battery module according to an embodiment.

Referring to FIG. 4, the controller 150 may be positioned at or in the space portion 140 at one end of the upper battery module 100. For example, the controller 150 may be physically and electrically connected to the upper and lower bus-bars 115 and 215. The upper bus-bar 115 may be downwardly bent along one end surface of the upper housing 110, and the lower bus-bar 215 may be upwardly bent along the one end surface of the upper housing 110.

The first and second holes 115a and 125a may be formed in the upper and lower bus-bars 115 and 125, respectively, so as to correspond or align with the upper hole 150a at one side or end of the controller and the lower hole 150b at another side or end of the controller 150, respectively. The first hole 115a and the upper hole 150a may be fastened to each other by one first fastening member 151, and the second hole 125a and the lower hole 150b may be fastened to each other by another first fastening member 151, so that the controller 150 may be connected to the upper and lower bus-bars 115 and 125.

FIG. 5 illustrates a perspective view showing the upper battery module according to an embodiment.

Referring to FIG. 5, the upper battery module 100 according to an embodiment may include the plurality of upper battery cells 10 arranged in one direction. Each upper battery cell 10 may be manufactured by, e.g., accommodating an electrode assembly and an electrolyte in a case and then sealing the case with a cap plate. The upper terminal portions 11 and 12 (and a vent between the upper terminal portions 11 and 12) may be formed on the cap plate.

The electrode assembly may include a positive electrode plate, a negative electrode plate, and a separator interposed between these electrode plates. In an implementation, the positive and negative electrode plates are connected to positive and negative electrode terminals, respectively, so that energy generated by an electrochemical reaction of the electrode assembly and the electrolyte may be transferred to the outside of the upper battery cell 10. The vent may serve as a passage through which gas generated inside the upper battery cell 10 is exhausted to the outside.

The plurality of upper battery cells 10 may be accommodated by a pair of end plates 20 and 30 (disposed at outer ends of the plurality of upper battery cells 10) and connection members 40 and 50 (connecting the pair of end plates 20 and 30 to each other).

For example, the plurality of upper battery cells 10 may be aligned in one direction in a space defined by the pair of end plates 20 and 30 and the connection members 40 and 50 connecting the pair of end plates 20 and 30 to each other.

The plurality of upper battery cells 10 may include a bottom plate 60 supporting bottom surfaces thereof, and a top plate 130 covering top surfaces thereof so that the upper terminal portions 11 and 12 and the upper bus-bar 115 are exposed. Both sides of the bottom plate 60 and the top plate 130 may be fastened by the pair of end plates 20 and 30. For example, the pair of end plates 20 and 30, the connection members 40 and 50, the bottom plate 60, and the top plate 130 may be fastened by a fastening member such as a bolt and nut.

The pair of end plates 20 and 30 may come into surface contact with respective outermost upper battery cells 10. Thus, the pair of end plates 20 and 30 may apply pressure toward the inside of the plurality of battery cells 10. In an implementation, the plurality of upper battery cells 10 may be arranged so that the polarities of the terminal portions 11 and 12 are alternately positioned. Thus, the plurality of upper battery cells 10 may be connected in series by the upper bus-bar 115.

The end plates 20 and 30, the connection members 40 and 50, the bottom plate 60, and the top plate 130 may facilitate stable fixing of the plurality of upper battery cells 10. However, in an implementation, the connection structure and number of the upper battery cells 10 may be variously modified according to the design of the battery pack.

In the aforementioned embodiment, a fuse is illustrated as the controller. However, it will be apparent that another component capable of controlling the battery pack, e.g., a junction box, fan, temperature measurer, or safety device, may be positioned along with or in place of the fuse. Although it has been described that the space portion is formed at the one end of the upper battery module, this is provided for illustrative purposes. For example, the embodiments may include a case where the space portion is formed at one end of the lower battery module. The space portion is not necessarily formed by the difference in number between the upper and lower battery modules. For example, the embodiments may include a case where, although the upper and lower battery modules include the same number of battery cells, a space portion is formed by changing an arrangement of the battery cells.

By way of summation and review, a small-sized mobile device, e.g., a cellular phone, may be operated with the power and capacity of a single battery cell for a certain period of time. In a case where an electric vehicle or hybrid vehicle having high power consumption requires long-time driving and high-power driving, a large-capacity battery module may be configured by electrically connecting a plurality of battery cells so as to increase power and capacity. The battery module may increase output voltage or output current according to a number of battery cells built therein. In addition, a battery pack may be configured by electrically connecting a plurality of battery modules.

The embodiments provide a battery pack capable of improving space efficiency.

The embodiments provide a battery pack including battery modules disposed at upper and lower portions thereof, in which a controller is positioned in a space portion of any one of upper and lower battery modules, thereby improving space efficiency.

The embodiments also provide a battery pack in which a controller is positioned between upper and lower battery modules, so that it is possible to improve safety and to facilitate cooling and replacement of the controller.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
an upper battery module including:
a plurality of upper battery cells arranged in one direction, the plurality of upper battery cells having upper terminal portions,
an upper bus-bar electrically connecting the upper terminal portions, and
an upper housing accommodating the plurality of upper battery cells therein; and
a lower battery module including:
a plurality of lower battery cells arranged in the one direction, the plurality of lower battery cells having lower terminal portions,
a lower bus-bar electrically connecting the lower terminal portions, and
a lower housing accommodating the plurality of lower battery cells therein,
wherein:
a space portion is formed at one end of any one of the upper and lower battery modules, and
a controller is positioned in the space portion.

2. The battery pack as claimed in claim 1, wherein:
one side of the controller is connected to a portion of the upper bus-bar at an end of the upper battery module, and
another side of the controller is connected to a portion of the lower bus-bar positioned at an end of the lower battery module.

3. The battery pack as claimed in claim 2, wherein:
the controller includes an upper hole at one side thereof,
the upper bus-bar includes a first hole aligned with the upper hole,
the controller includes a lower hole at another side thereof,
the lower bus-bar includes a second hole aligned with the lower hole,
the upper hole and the first hole are fastened to each other with one first fastening member, and
the lower hole and the second hole are fastened to each other with another first fastening member.

4. The battery pack as claimed in claim 1, wherein the upper bus-bar is downwardly bent along one end surface of the upper housing from an upper surface of the upper battery module.

5. The battery pack as claimed in claim 4, wherein the lower bus-bar is upwardly bent along the one end surface of the upper housing from an upper surface of the lower battery module.

6. The battery pack as claimed in claim 5, wherein:
the space portion is at the one end of the upper battery module, and
a bottom surface, on which the space portion of the upper housing is formed, extends to cover an upper surface of the lower housing, the bottom surface including a through-portion through which the lower bus-bar passes.

7. The battery pack as claimed in claim 1, further comprising a controller cover on an outside of the controller.

8. The battery pack as claimed in claim 7, wherein:
the controller cover includes a cover fixing hole,
the upper housing includes a cover fixing groove, the cover fixing groove being aligned with the cover fixing hole, and
the cover fixing hole and the cover fixing groove are fastened to each other with a second fastening member.

9. The battery pack as claimed in claim 8, wherein the controller cover covers the controller, a connection between the controller and the upper bus-bar, and a connection between the controller and the lower bus-bar.

10. The battery pack as claimed in claim 1, wherein the controller includes at least one selected from the group of a fuse, a junction box, a battery control unit (BCU), a fan, and a temperature measurer.

11. The battery pack as claimed in claim 1, wherein:
the upper hosing further includes an upper flange portion on both side portions of a bottom surface thereof, the upper flange portion being bent toward a side surface of the lower housing from, and
the lower housing further includes a lower flange portion extending from both side surfaces thereof, the lower flange portion contacting an inner surface of the upper flange portion.

12. The battery pack as claimed in claim 11, wherein:
the upper flange portion includes at least one upper module fastening hole,
the lower flange portion includes a lower module fastening hole, the lower fastening hole being aligned with the upper module fastening hole, and
the upper and lower module fastening holes are fastened to each other with a third fastening member.

13. The battery pack as claimed in claim 1, wherein the upper housing has an open upper end, and the battery pack further includes an upper cover covering the open upper end of the upper housing.

14. The battery pack as claimed in claim 1, wherein a number of the upper battery cells in the battery pack is smaller than a number of the lower battery cells in the battery pack.
